(19) United States
(12) Patent Application Publication
(10) Pub. No.: US 2010/0206905 A1
(43) Pub. Date: Aug. 19, 2010

(54) DUAL FLUID DISPENSER

(75) Inventors: Terry A. Horner, Allentown, NJ (US); Matthew E. Pappalardo, Ewing, NJ (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/668,485

(22) PCT Filed: Aug. 6, 2008
(86) PCT No.: PCT/US08/72328

§ 371 Date: Jan. 11, 2010

Related U.S. Application Data
(60) Provisional application No. 60/963,631, filed on Aug. 6, 2007.

(51) Int. Cl. B67D 7/70

(52) U.S. Cl. 222/137; 222/145.5; 222/326

(57) ABSTRACT

A dual fluid cartridge for storing and dispensing fluids. With the disclosed dual fluid cartridge, a hand-held applicator may be used to dispense and mix two component end products (e.g., an adhesive) in unequal ratios. The dual fluid cartridge is configured as a syringe. Such an ability to dispense a two component end product is especially useful in the dental field.

This application claims the benefit of U.S. Provisional Patent Application Ser. No. 60/963,631, filed Aug. 6, 2007 (pending), the disclosure of which is fully incorporated by reference herein.

### BACKGROUND

In the dental field, dental practitioners often prefer using dispensing cartridges that can be disposed of after use with one patient. These are typically referred to as single dose cartridges. Single dose cartridges provide several significant advantages over multi-use cartridges. Single dose cartridges are more sanitary than multi-use cartridges. With a single use cartridge, the dental practitioner can dispose of the cartridge after the procedure is complete, thereby, reducing the possibility of spreading germs and infection among patients. Also, single dose cartridges do not have as much waste as a multi-use cartridge. With a multi-use cartridge, the resin and hardener components often times cross-contaminate between uses, causing the adhesive to harden and rendering the cartridge useless. The dental practitioner, as a result in this case, is only able to get two to three uses out of the multi-use cartridge and does not achieve the benefit of using the cartridge multiple times.

The single dose dispensing system that many present dental practitioners use consists of a re-usable hand-held applicator and a disposable single component, single dose cartridge that fits into the hand-held applicator. U.S. Pat. Nos. 5,306,147 and 6,095,814 illustrate examples of such single dose dispensing systems. These systems are for dispensing single component fluids. They are not, however, the most appropriate choice when two fluids are required. Presently, a dental practitioner that wants to apply a two component adhesive has to dispense one fluid (e.g., typically a resin) from a single dose cartridge onto a surface and then dispense a second fluid (e.g., typically a hardener) from a second single dose cartridge, and then hand mix the two together. This process is time consuming and cumbersome and not the most efficient way for a dental practitioner to mix a two component adhesive.

Dental practitioners also often have to dispense fluids in unequal ratios, other than 1:1.

There is a continuing need for improvements in dual fluid dispensers, especially with regard to single dose dispensers, but with features also applicable to or desirable for multi-use dispensers.

### SUMMARY

The present invention generally provides a self-contained dual fluid dispenser for storing and dispensing two fluids. The dispenser includes a dual fluid container having an outer cartridge wall and a first outlet at a distal end, and an open proximal end. A delivery tube is disposed at least partially within the outer cartridge wall and includes a second outlet. A first piston is disposed between the outer cartridge wall and the delivery tube so as to form a first fluid chamber for a first fluid. A neck may be connected with the outer cartridge wall and may be coupled to an applicator. Alternatively, the neck may be eliminated such that, for example, the dispenser may be configured as a syringe. In embodiments having a neck, a second piston is disposed at least partially within the neck and at least partially defines a second fluid chamber for a single dose of a second fluid. The second chamber extends proximally from the open proximal end of the outer cartridge wall. A transmission structure is operative to transmit force from the second piston to the first piston to thereby dispense the first and second fluids from the first and second outlets. The transmission structure may be connected with or even formed integrally with the first piston depending, for example, whether the chambers are to be filled separately or simultaneously with the respective fluids.

As further aspects, the second fluid chamber is further defined by a side wall connected with a piston surface and the side wall may comprise the transmission structure. The sidewall slides within the neck in a telescoping manner and also slides over the delivery tube in a telescoping manner. A mixer is operatively attached to the outer cartridge wall so as to receive the first and second fluids from the first and second outlets. The neck may be integral with or releasably coupled to the outer cartridge wall.

The invention further provides a dispenser assembly that includes an applicator with a force providing mechanism in combination with a self-contained dual fluid dispenser having one or more of the features discussed herein. The force providing mechanism may take any suitable form and is adapted to provide a force to the second piston which then transmits the force to the first piston via the transmission structure.

Various additional details and features of the invention will become more readily apparent to those of ordinary skill in the art upon review the following detailed description of the illustrative embodiments taken in conjunction with the accompanying drawings.

### DESCRIPTION OF THE DRAWINGS

These and other features, aspects and advantages of the present invention will become better understood with regard to the following description and accompanying drawings where:

FIG. 1A is a perspective view of an embodiment of a cartridge of the present invention with a cap in place.

FIG. 1B is a perspective view of an embodiment of a cartridge of the present invention with the cap removed and a mixing nozzle attached.

FIG. 2A is a perspective view of a hand-held applicator with the plunger and extension exposed, an embodiment of the cartridge of the present invention and a mixing nozzle.

FIG. 2B is a perspective view of a hand-held applicator, in a resting position, with the plunger and extension exposed and having a cartridge inserted with a mixing nozzle attached.

FIG. 2C is a perspective view of a hand-held applicator, in a compressed position, with the plunger exposed and having a cartridge inserted with a mixing nozzle attached.

FIG. 3 is a longitudinal sectional view of a filled embodiment of a dual fluid cartridge of the present invention, which is depicted along with an attached nozzle and static mixer in section and a portion of the extension of the plunger depicting in FIGS. 2A and 2B.

FIG. 4 is a longitudinal sectional view of the dual fluid cartridge depicted in FIG. 3 in an intermediate dispensing position.

FIG. 5 is a longitudinal sectional view of the dual fluid cartridge depicted in FIG. 3 with the contents of the dual fluid cartridge dispensed.

FIG. 6 is a longitudinal sectional view of a dual fluid syringe type dispenser according to an alternative embodiment of the invention.

### DETAILED DESCRIPTION

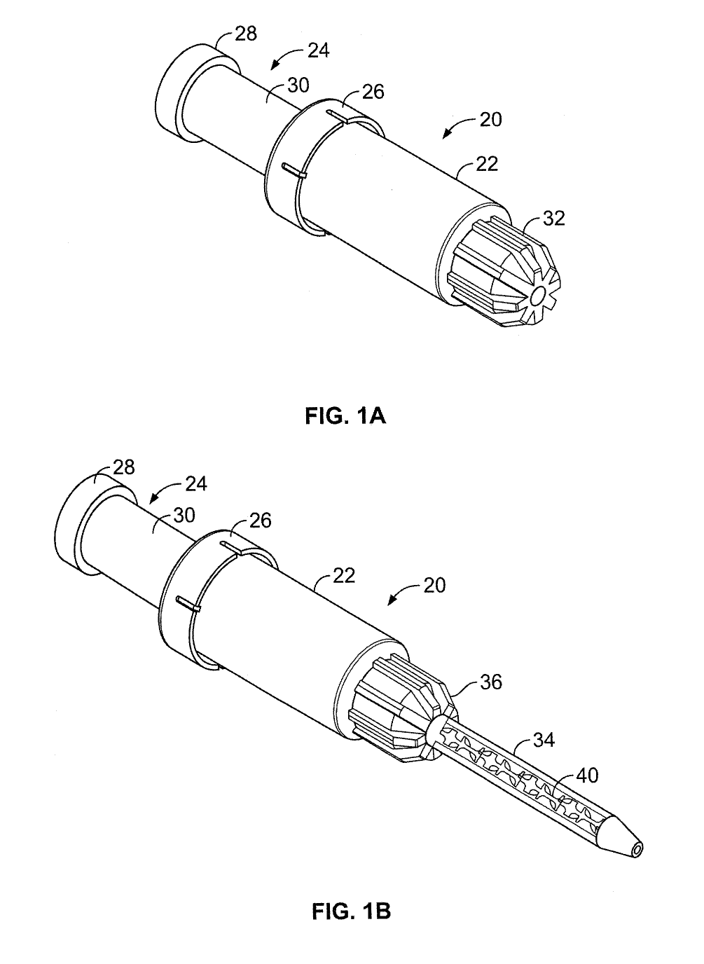

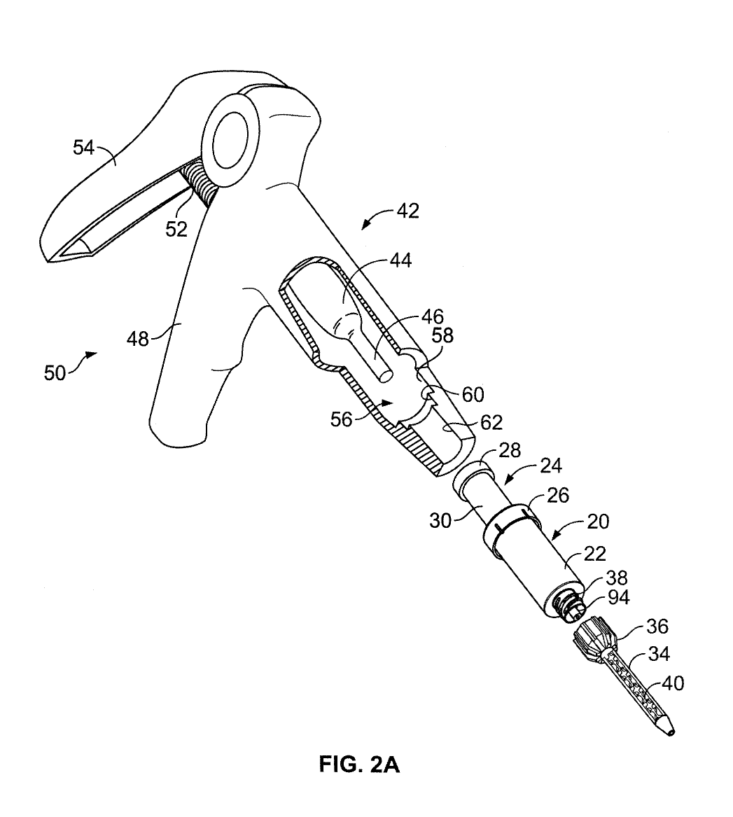

Referring to FIGS. 1A and 1B, an embodiment of a single dose, dual fluid cartridge 20 operative as a dispenser for storing and dispensing fluids in unequal ratios of the present invention is depicted. The embodiment depicted is a 10:1 fluid ratio embodiment of the dual fluid cartridge 20, but it should be understood that other embodiments of the cartridge with other fluids ratios could be utilized without departing from the invention disclosed herein. In addition, the features described herein may also be applied to multi-use dispensers. The dual fluid cartridge 20 includes an outer cartridge wall 22 and a bottom 24. The bottom 24, in this embodiment, has a snap collar 26 which snaps onto the outer cartridge wall 22. In other embodiments, the bottom 24 may be formed to connect with the outer cartridge wall 22 in a different manner, including having the bottom 24 welded, threaded or formed integral with the outer cartridge wall 22. The snap collar 26 could be eliminated and replaced by other structure for closing the back end of the cartridge wall 22. Further, the bottom 24 includes a seating collar 28 and a neck 30. As explained in detail below, the dual fluid cartridge 20 stores two fluids separate from one another that when mixed together react chemically to form an end product, such as an adhesive. The dual fluid cartridge 20 of this embodiment stores just enough of the component fluids to create a single dose of the end product upon dispensing. FIG. 1A shows the dispensing cartridge 20 with a threaded cap 32 in place. The threaded cap 32 is in place during shipping and prior to use. FIG. 1B shows the dispensing cartridge 20 ready for use with the threaded cap 32 removed and a nozzle 34 attached to the cartridge 20. The nozzle 34 is attached to the cartridge 20 by a retaining nut 36, which is threaded onto a threaded outlet 38 of the cartridge 20 (FIG. 2A), although it may be attached in any suitable manner such as bayonet, snap-fit, etc. Typically, the nozzle 34 contains a static mixer 40 within it. The static mixer 40 mixes the two fluids stored in the dual fluid cartridge 20 together as they are dispensed from the cartridge 20.

Referring to FIGS. 2A-2C, the dual fluid cartridge 20 of the present invention is used with a hand-held applicator 42, such as the one depicted in FIGS. 2A-2C. The hand-held applicator 42 is a standard hand-held applicator available in the marketplace. Such hand-held applicators are commonly used in the dental field. It should be understood, further, that the dual fluid cartridge 20 of the present invention is not limited to use in just the dental field. The dual fluid cartridge 20 of the present invention may be used with a hand-held applicator in any field of use. It should also be understood that the cartridge 20 of the present invention may be used with or modified for any hand-held applicator and is not limited to being just used with the illustrative example depicted in the figures.

The hand-held applicator 42 shown in FIGS. 2A-C has a plunger 44 with an extension 46. The plunger 44 extends back through a front portion 48 of a handle 50 of the hand-held applicator 42. The hand-held applicator 42 also has a plunger channel 56 at the front of the applicator 42 which defines a travel path for the plunger 44 when the applicator 42 is used. The plunger channel 56, at the front end, has three different sections 58, 60, 62 of varying widths to receive and hold the cartridge 20, as explained in more detail below. The back section 58 has the widest width, the middle section 60 is narrower and the front section 62 is the narrowest.

The plunger 44 of the hand-held applicator 42 butts up against a back portion 54 of the handle 50. The portion of the plunger 44 between the front and back portions 48, 54 of the handle 50 is disposed within a spring 52. When a user presses on the back portion 54 of the handle 50, the plunger 44 and the extension 46, through a cam mechanism, are pressed forward in the plunger channel 56, and the spring 52 is compressed (FIG. 2C). When the back portion 54 of the handle 50 is released, the potential energy contained in the spring 52 pushes the plunger 44 and the back portion 54 of the handle 50 back to a resting position (FIG. 2B).

Referring to FIGS. 2A and 2B, in this embodiment, the cartridge 20 is loaded into the applicator 42 by lining up the seating collar 28 with the wide back section 58 of the plunger channel 56 and dropping the cartridge 20 into the plunger channel 56. The cartridge 20 is then pulled forward in the plunger channel 56 so that the seating collar 28 seats in the middle section 60 and the neck 30 of the cartridge 20 sits securely in the narrowest diameter of the front section 62. This is commonly referred to as a “breach-loading” arrangement. The cartridge 20, as depicted in FIG. 2B, is then seated in the applicator 42 and ready for use. It should be understood that the seating arrangement described above is just one way in which the cartridge 20 may be designed to fit in an applicator 42. The snap collar 26 may be eliminated and replaced by other structure for closing the back end of the cartridge 20. The bottom 24 may also be reconfigured in any manner, as necessary, to fit into any intended applicator 42. For example, instead of a breach-loading arrangement, the cartridge 20 may be snapped into plunger channel 56 and be held in place by an interference fit. This is one reason why the bottom 24 is separate from the outer cartridge wall 22 so that differently configured bottoms 24 can be used with and snapped onto a standard outer cartridge wall 22 configuration.

Depending on the amount of end product required, the cartridge 20 may be made of different sizes by adjusting the outer cartridge wall 22 portion of the cartridge 20. It should noted though that, in this embodiment, no matter what size the outer cartridge wall 22 and the snap collar 26 are formed at, the seating collar 28 and the neck 30 always remain the same size so that they fit into the plunger channel 56 and the seating sections 58, 60 and 62 of the applicator 42.

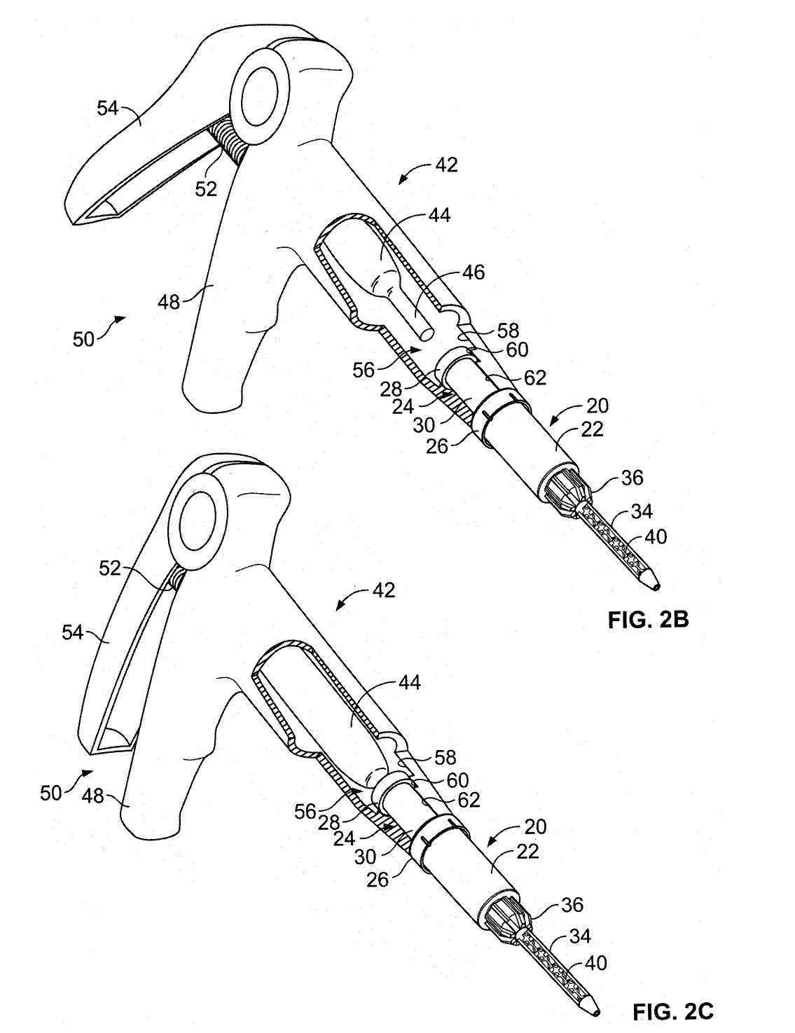

Referring now to FIG. 3, a longitudinal sectional view of an embodiment of a dual fluid cartridge 20 of the present invention is depicted. This embodiment of the dual fluid cartridge 20 defines a first fluid chamber 70 and a second fluid chamber 72 for storing and dispensing a first fluid 78 and second fluid 80 respectively. In this embodiment of the dual fluid cartridge 20, the cartridge 20, in addition, includes the outer cartridge wall 22, a delivery tube 74, a first piston 76 having an exterior seal 77 and an interior seal 79, a compression wall 82 having a seal 83 and a bottom fluid assembly 110. The bottom fluid assembly 110 and, specifically, a rear piston surface 96 thereof, serves as a second piston as will be discussed below. The seals 77, 83 are annular dimples in this embodiment and the seal 79 is created by a fit between components, but it should be understood that other sealing arrangements may be used (e.g., o-rings or lip seals). The outer cartridge wall 22 in this embodiment is a cylindrical wall defining a hollow interior 86 and having raised venting bosses 120 formed thereon. The outer cartridge wall 22, in this embodiment, at the back end has an annular snap ridge 88. The snap collar 26 of the bottom 24, when the cartridge 20 is assembled, is snapped onto the outer cartridge wall 22 and engages the snap ridge 88. The outer cartridge wall 22 at the other end, the front end, defines a discharge opening 90 and includes the external threaded outlet 38.

The bottom fluid assembly 110 is disposed within the interior of the neck 30 of the bottom 24. The bottom fluid assembly 110 includes a sidewall transmission structure 112 having raised venting bosses 122 formed thereon and the rear piston surface 96. By having the bottom fluid assembly 110 occupy the interior space of the neck 30 with fluid, it makes the cartridge 20 of this invention more useable where the fluid ratios are significantly unequal. In prior designs, there is no fluid stored in the interior of the neck 30. As a result, in these prior designs, to accommodate fluids of significantly differing ratios, the outer cartridge wall 22 has to be increased. At higher ratio differentials, though, the size of the outer cartridge wall 22 can become unwieldy and difficult to work with. As such, by developing a bottom fluid assembly 110 that stores fluid in the neck 30 of the cartridge 20, greater ratio differentials can be achieved without significantly increasing the size of the outer cartridge wall 22.

The delivery tube 74 of the cartridge 20 is disposed within the hollow interior 86 of the outer cartridge wall 22. In this embodiment, the delivery tube 74 snaps into locking engagement with the outer cartridge wall 22 at a snap connection 92. The delivery tube 74 defines an outlet 94 that extends within and beyond the outlet 90 in this embodiment. It is foreseen that the outer cartridge wall 22 and the delivery tube 74 may also be formed integral with one another, and it is also foreseen that different outlet configurations for the outlets 90, 94 may be adopted other than the one depicted in the figures. The compression wall 82 in this embodiment is formed integral with the delivery tube 74 which fixes the compression wall 82 in place. Also, in this embodiment, the delivery tube 74 extends into the bottom fluid assembly 110.

The first piston 76 of the dual fluid cartridge 20 is disposed within the cartridge 20 between the exterior of the delivery tube 74 and the interior of the outer cartridge wall 22. In this embodiment, the first piston 76 surrounds the exterior of the delivery tube 74. The first piston 76, in conjunction with the exterior of the delivery tube 74 and the interior of the outer cartridge wall 22, define the first fluid chamber 70.

In this embodiment, the bottom fluid assembly 110 and the compression wall 82 define the second fluid chamber 72. The delivery tube 74 provides fluid communication between the second fluid chamber 72 and the discharge opening 94. The bottom fluid assembly 110 in this embodiment does not include a post, but in other embodiments, a post may be used to minimize fluid waste as disclosed in commonly owned U.S. Pat. No. 5,310,091 and U.S. patent application Ser. No. 11/031,929.

Further, it should be understood that the differing portions 96, 112 of the bottom fluid assembly 110 are all integral with one another in this embodiment, but this is not necessary. One of ordinary skill in the art would understand that it is possible that each portion of the bottom fluid assembly 110 could be its own separate structure. In this embodiment, the transmission structure 112 extends from the rear piston surface 96 of the bottom fluid assembly 110, passes snugly between the compression wall 82 and the interior of the neck 30 forming a seal. In this embodiment, in the filled position, there is a gap 124 formed between the end of the transmission structure 112 and the first piston 76. The gap 124, as described in detail below, causes a small amount of the second fluid 80 to be dispensed before the first fluid 78.

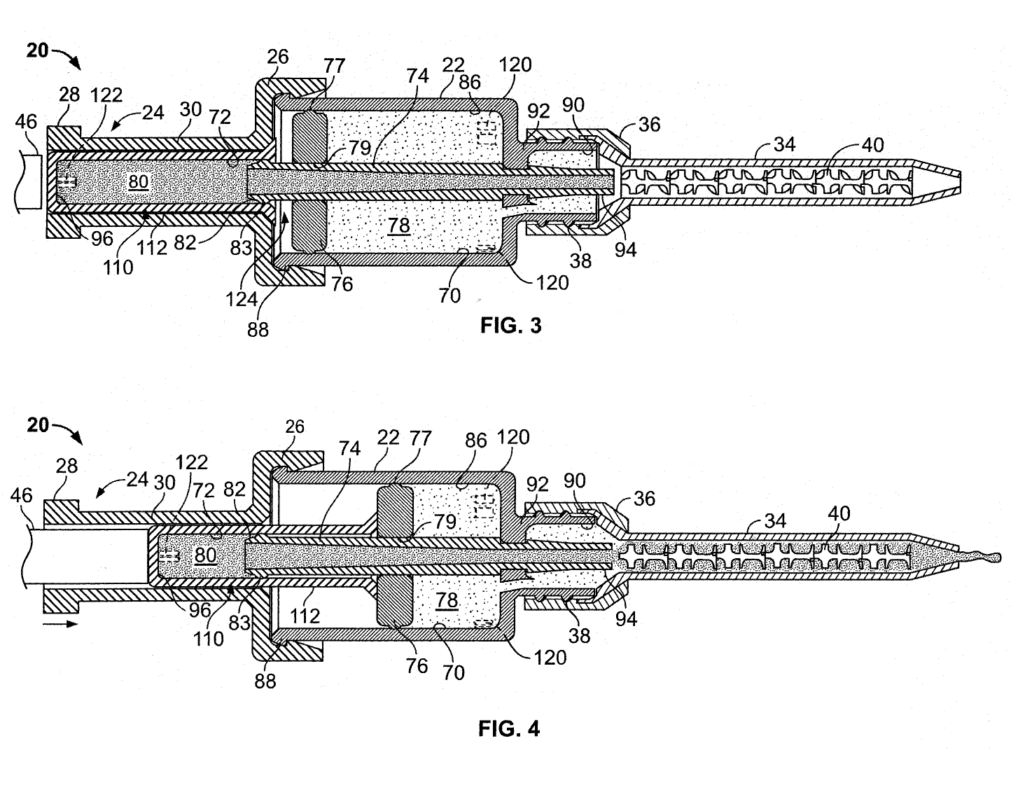

To dispense the fluids from the dual fluid cartridge 20, the bottom fluid assembly or second piston 110 is pressed forward towards the front of the cartridge. In the embodiment described, this is done by actuation of the hand-held applicator 42. Referring to FIG. 2B, in particular, the user presses the rear portion 54 of the handle 50 towards the front portion 48 of the handle 50. As a result, the plunger 44 and extension 46 are pressed forward in the plunger channel 56, in the direction indicated by the arrow in FIG. 4. In this movement, the tip of the extension 46 presses against the bottom fluid assembly 110, entering the end collar 24. In this embodiment, the rear piston surface 96 pushes against the fluid 80 stored in chamber 72 which is disposed in the neck 30. The fluid 80 being pushed by the rear piston surface 96 in the chamber 72 gets compressed by the fixed compression wall 82, pushing the fluid 80 through the delivery tube 74 and through the discharge opening 94, where the fluid 80 is discharged from the dual fluid cartridge 20. Also, as the extension 46 presses against the bottom fluid assembly 110, the transmission structure 112 closes the gap 124 and then presses against the first piston 76. The pressing of the transmission structure 112 against the first piston 76 causes the fluid 78 in the first fluid chamber 70 to be pressed into the discharge opening 90, through which the fluid 78 is discharged from the dual fluid cartridge 20. As the fluids 78, 80 are discharged from the dual fluid cartridge 20 through the discharge openings 90, 94, they are mixed together by the static mixer 40 in the nozzle 34. In this embodiment, the gap 124 causes a small amount of the second fluid 80 to dispense ahead of the first fluid 78 to provide a small amount of extra catalyst during initial dispensing to ensure the fluids 78, 80 are fully mix at the beginning of the first dispense bead.

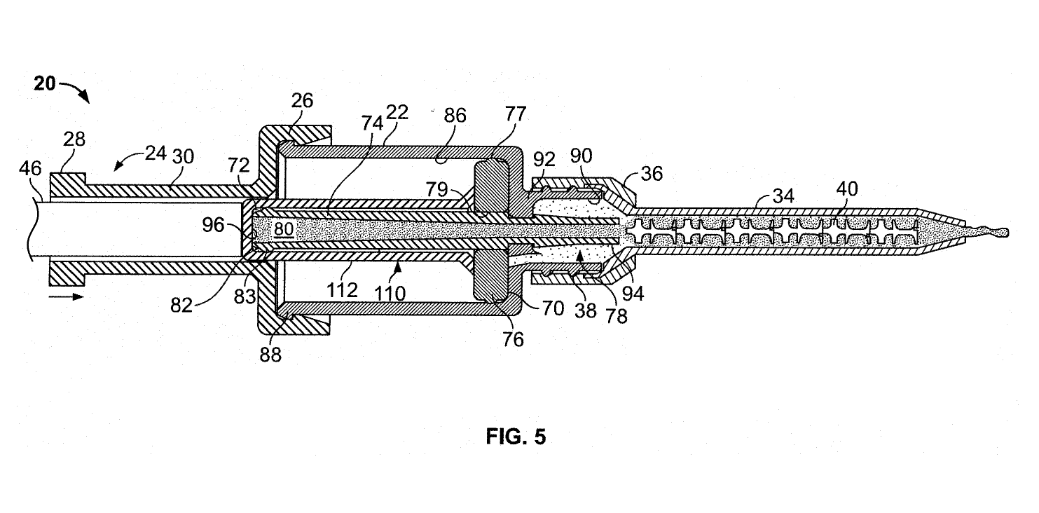

This fluid discharge and mixing process continues as long as the plunger 44 and extension 46 are being actuated and as long as fluids are still left to be dispensed from the dual fluid cartridge 20. FIG. 4 depicts the dual fluid cartridge 20 in an intermediate dispensing position with a portion of the fluids 78, 80 dispensed from the dual fluid cartridge 20. FIG. 5 depicts the dual fluid cartridge 20 with the fluid contents of the chambers 70, 72 of the cartridge 20 fully dispensed.

The arrangement of the dual fluid cartridge 20 in FIG. 5, minus the waste fluids 78 and 80 shown remaining, is how the dual fluid cartridge 20 looks prior to being filled. To fill the dual fluid cartridge 20, the chambers 70, 72 are filled with the appropriate fluids 78, 80 through their respective discharge openings 90, 94. The filling process occurs in the reverse manner of the dispensing process described above. During the filling process, air is present in the chamber 70, 72 between the incoming fluids 78, 80 and the pistons 76, 96. If air gets trapped in the chambers 70, 72, it can cause a number of problems in the use of the dual fluid cartridge 20. Most significantly, air trapped in chambers 70, 72 can negatively impact he ability to control the volumetric dispensing ratio of the fluids 78, 80 in the chambers 70, 72. To alleviate this problem, an air venting system may be employed, such as the air venting system described in commonly owned international patent application number PCT/US03/17997 or U.S. patent application Ser. Nos. 10/755,796 and 11/031,929, which are incorporated by reference herein. In this embodiment, to vent this air, raised bosses 120 are formed on the interior of the outer cartridge wall 22, and raised bosses 122 are also formed on the interior wall of the bottom can assembly 110. The raised bosses 120, 122 temporarily open the seals formed by seals 76, 83, respectively, at the beginning of the filling process. As fluid enters the chambers 70, 72, after the air has been vented, the seals 76, 83 move off of the raised bosses 120, 122 and seal the chambers 70, 72 as described above.

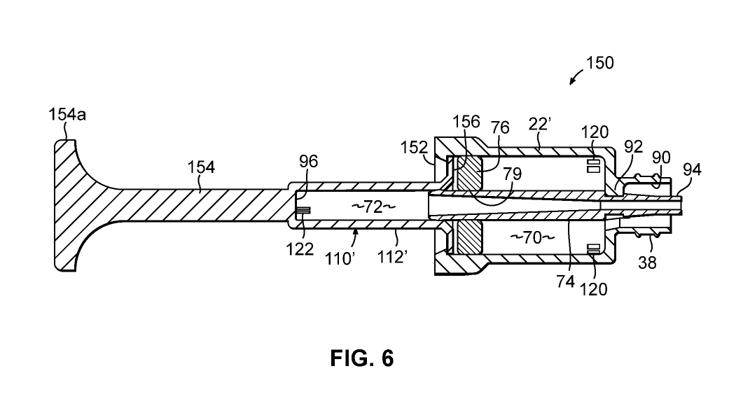

FIG. 6 illustrates a syringe-type dual fluid dispenser 150 according to an alternative embodiment of the invention. Identical reference numerals contained in both FIG. 6 and one or more of the previously described figures refer to like structure having like function, while like reference numerals with prime marks (′) in FIG. 6 refer to analogous elements from the first embodiment that have been somewhat modified as will be described below and/or apparent from a comparison of the figures associated with the different embodiments. For a further understanding of the identical structure, reference may be made to the description above. It will be understood that although not shown in FIG. 6, a mixing nozzle 34 (FIG. 3) is attached to the threaded outlet 38, such as in the manner previously described. The syringe dispenser 150 includes an outer, cylindrical cartridge wall 22′ containing a first, annular piston 76 as in the first embodiment. The first piston 76 is located between the delivery tube 74 and the outer cartridge wall 22′ and defines a first fluid chamber 70 for holding a first fluid (not shown). Similar to the previous embodiment, but somewhat different in design, the outer cartridge wall 22′ includes an open proximal end 152. A movable bottom fluid assembly 110′ extends through the open end 152 and defines transmission structure 112′ having a similar purpose to the first embodiment, as previously described. In this embodiment, however, the bottom fluid assembly 110′ and transmission structure 112′ are part of, or at least coupled for movement with a manually operable plunger 154 of the syringe dispenser 150. That is, the neck 30 of the previous embodiment has been eliminated since this embodiment does not involve attachment to a hand-held applicator or gun. When the syringe dispenser 150 is in the pre-dispense condition shown in FIG. 6, at least a portion of the second fluid chamber 72 is located proximal to the open end 152. When the plunger 154 is depressed by a user engaging the thumb knob 154a, while grasping outer wall 22′ and attached flanges (not shown) with their fingers, a distal flange portion 156 engages the first piston 76 and moves it distally in the same manner as previously described. The bottom fluid assembly 110′ and transmission structure 112′ are coupled with the outer wall 22′ such that they do not uncouple. In this regard, the open end 152 is formed as an inwardly directed flange portion which retains the outwardly directed flange portion 156. It will be appreciated that the remaining functions and operation of the syringe dispenser 150 to dispense and mix two fluids are as described with respect to the first embodiment. That is, piston 76 will extrude a first fluid from the first fluid chamber 70 through the outlet 38 while the piston surface 96 will extrude the second fluid from the outlet 94. Both fluids may enter a mixing nozzle (FIG. 3) as previously described.

It should be understood that many differing embodiments of the dual fluid cartridges 20 and 150 of the present invention may be designed and employed.

While the invention has been discussed in terms of certain embodiments, it should be appreciated that the invention is not so limited. The embodiments are explained herein by way of example, and there are numerous modifications, variations and other embodiments that may be employed that would still be within the scope of the present invention. The various features described herein may be combined in any manner, or used with other features, depending on the needs of the application.

What is claimed is:

1. A self-contained dual fluid dispenser for storing and dispensing two fluids, comprising:
a dual fluid container having an outer cartridge wall and a first outlet at a distal end and an open proximal end;
a delivery tube disposed at least partially within the outer cartridge wall and including a second outlet;
a first piston disposed between the outer cartridge wall and the delivery tube, the first piston forming a first fluid chamber for a first fluid;
a second piston at least partially defining a second fluid chamber for a second fluid, the second chamber extending proximally from the open proximal end of the outer cartridge wall; and
a transmission structure operative to transmit force from the second piston to the first piston to thereby dispense the first and second fluids from the first and second outlets.

2. The self-contained dual fluid dispenser of claim 1, wherein the second fluid chamber is further defined by a side wall connected with a piston surface.

3. The self-contained dual fluid dispenser of claim 2, wherein the side wall comprises the transmission structure.

4. The self-contained dual fluid dispenser of claim 1, further comprising:
a neck connected with the outer cartridge wall and adapted to be coupled to an applicator; and
wherein the second piston is disposed at least partially within the neck.

5. The self-contained dual fluid dispenser of claim 2, wherein the sidewall slides over the delivery tube in a telescoping manner.

6. The self-contained dual fluid dispenser of claim 1, further comprising a mixer operatively attached to the outer cartridge wall so as to receive the first and second fluids from the first and second outlets.

7. The self-contained dual fluid dispenser of claim 1, wherein the neck is releasably coupled to the outer cartridge wall.

8. The self-contained dual fluid dispenser of claim 1, wherein the dispenser is configured as a syringe.

9. A self-contained dual fluid dispenser for storing and dispensing two fluids, comprising:
a dual fluid container having an outer cartridge wall and a first outlet;
a delivery tube disposed at least partially within the outer cartridge wall and including a second outlet;
a first piston disposed between the outer cartridge wall and the delivery tube, the first piston forming a first fluid chamber for a first fluid;
a neck connected with the outer cartridge wall and adapted to be coupled to an applicator;
a second piston disposed at least partially within the neck and coupled with a side wall defining a second fluid chamber for a second fluid wherein the side wall slides within the neck in a telescoping manner and also slides over the delivery tube in a telescoping manner; and
a transmission structure operative to transmit force from the second piston to the first piston to thereby dispense the first and second fluids from the first and second outlets.

10. The self-contained dual fluid dispenser of claim 9, wherein the side wall comprises the transmission structure.

11. The self-contained dual fluid dispenser of claim 9, further comprising a mixer operatively attached to the outer cartridge wall so as to receive the first and second fluids from the first and second outlets.

12. The self-contained dual fluid dispenser of claim 9, wherein the neck is releasably coupled to the outer cartridge wall.

13. A dual fluid dispenser assembly, comprising:
an applicator including a force providing mechanism;
a dual fluid container having an outer cartridge wall and a first outlet;
a delivery tube disposed at least partially within the outer cartridge wall and including a second outlet;
a first piston disposed between the outer cartridge wall and the delivery tube, the first piston forming a first fluid chamber for a first fluid;
a neck connected with the outer cartridge wall and further coupled to the applicator;
a second piston disposed at least partially within the neck and at least partially defining a second fluid chamber for a second fluid, the second piston adapted to receive a force from the force providing mechanism to move the second piston; and
a transmission structure operative to transmit force from the second piston to the first piston to thereby move the first piston and dispense the first and second fluids from the first and second outlets.

14. The assembly of claim 12, wherein the second fluid chamber is further defined by a side wall.

15. The assembly of claim 14, wherein the side wall comprises the transmission structure.

16. The assembly of claim 14, wherein the side wall slides within the neck in a telescoping manner.

17. The assembly of claim 14, wherein the sidewall slides over the delivery tube in a telescoping manner.

18. The assembly of claim 13, further comprising a mixer operatively attached to the outer cartridge wall so as to receive the first and second fluids from the first and second outlets.

19. The assembly of claim 13, wherein the neck is releasably coupled to the outer cartridge wall.
